(19) United States
(12) Patent Application Publication
(10) Pub. No.: US 2009/0225556 A1
(43) Pub. Date: Sep. 10, 2009

(54) THERMOELECTRIC COOLER AND ILLUMINATION DEVICE USING SAME

(75) Inventors: CHIH-PENG HSU, Chu-Nan (TW); CHIH-MING LAI, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/233,005

(22) Filed: Sep. 18, 2008

(30) Foreign Application Priority Data
Mar. 4, 2008 (CN) 200810300461.5

(51) Int. Cl. B60Q 1/06; F25B 21/02

(52) U.S. Cl. 362/373; 62/3.7

(57) ABSTRACT

A thermoelectric cooler includes a plurality of P-type semiconductor elements, a plurality of N-type semiconductor elements, a plurality of connection circuits, a cold end and a hot end. The P-type semiconductor elements are electrically connected to the N-type semiconductor elements by the connection circuits. The P-type semiconductor elements, the N-type semiconductor elements and the connection circuits are sandwiched between the cold end and the hot end providing thermal connection therebetween. The cold end includes a first metal base and a first insulated metal oxide film formed on a side of the first metal base adjacent to the P-type semiconductor elements, the N-type semiconductor elements and the connection circuits.

### CROSS-REFERENCE TO RELATED APPLICATIONS

This application is related to the following commonly-assigned copending applications: Ser. No. 12206171, entitled “ILLUMINATION DEVICE” (attorney docket number US 18668). Disclosures of the above-identified application is incorporated herein by reference.

### BACKGROUND

1. Field of the Invention

The present invention generally relates to component cooling, and particularly to a thermoelectric cooler having high heat transfer efficiency, and an illumination device using the thermoelectric cooler.

2. Description of Related Art

In recent years, due to excellent light quality and high luminous efficiency, light emitting diodes (LED) have increasingly been used to substitute for cold cathode fluorescent lamps (CCFL) as a light source of an illumination device, referring to “Solid-State Lighting: Toward Superior Illumination” by Michael S. Shur, or others. on proceedings of the IEEE, Vol. 93, NO. 10 (October, 2005).

LEDs generate a significant amount of heat when working, with stability thereof affected by temperature. When the temperature of the LED is too high, light intensity of the LED may be attenuated gradually, shortening life of the device. Thus, a thermoelectric cooler may be used to transfer heat from the LED to a heat dissipation device, from which the heat can be dissipated efficiently. The thermoelectric cooler typically includes a cold end and a hot end, both of insulated material with high thermal resistance, such as ceramic, the thermoelectric cooler operating correspondingly on the Peltier effect. Thermal conductive adhesives are widely used to adhere the thermoelectric cooler to a printed circuit board (on which the LEDs are mounted), with the heat dissipation device acting as bonding medium. Heat dissipation efficiency of the illumination device is limited due to the high thermal resistance of the thermal conductive adhesive.

What is needed, therefore, is a thermoelectric cooler with improved heat transfer efficiency used in an illumination device which can overcome the described limitations.

### SUMMARY

A thermoelectric cooler includes a plurality of P-type semiconductor elements, a plurality of N-type semiconductor elements, a plurality of connection circuits, a cold end and a hot end. The P-type semiconductor elements are electrically connected to the N-type semiconductor elements by the connection circuits. The P-type semiconductor elements, the N-type semiconductor elements and the connection circuits are sandwiched between the cold end and the hot end providing thermal connection therebetween. The cold end includes a first metal base and a first insulated metal oxide film formed on a side of the first metal base adjacent to the P-type semiconductor elements, the N-type semiconductor elements and the connection circuits.

Other advantages and novel features of the present thermoelectric cooler will become more apparent from the following detailed description when taken in conjunction with the accompanying drawings, in which:

### BRIEF DESCRIPTION OF THE DRAWINGS

Many aspects of the present thermoelectric cooler and illumination device can be better understood with reference to the following drawings. The components in the drawings are not necessarily drawn to scale, the emphasis instead being placed upon clearly illustrating the principles of the present thermoelectric cooler and illumination device. Moreover, in the drawings, like reference numerals designate corresponding parts throughout the several views.

FIG. 1 is a cross-section of a thermoelectric cooler, in accordance with a first embodiment of the present invention.

FIG. 2 is a cross-section of a second insulated metal oxide film of the cold end of FIG. 2.

FIG. 3 is a cross-section of an illumination device, in accordance with a second embodiment of the present invention.

### DETAILED DESCRIPTION OF EMBODIMENTS

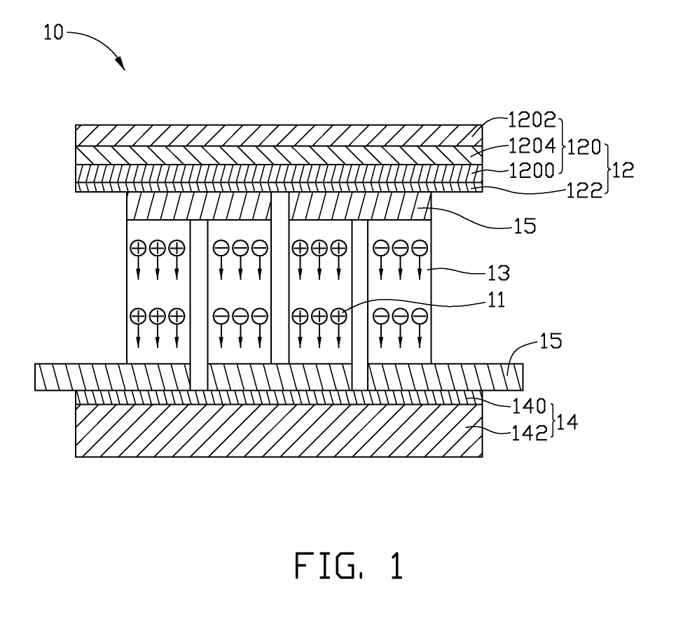

Referring to FIG. 1, a thermoelectric cooler 10, in accordance with a first embodiment, comprises a plurality of P-type semiconductor elements 11, a plurality of N-type semiconductor elements 13, a plurality of connection circuits 15, a cold end 12 and a hot end 14.

The connection circuits 15 are connected in series. The P-type semiconductor elements 11 are connected to the N-type semiconductor elements 13 by the connection circuits 15. The cold end 12 is arranged opposite to the hot end 14. The P-type semiconductor elements 11, the N-type semiconductor elements 13 and the connection circuits 15 are sandwiched between the cold end 12 and the hot end 14.

The P-type and N-type semiconductor elements 11, 13 can be tellurium compounds, such as bismuth telluride or antimony compounds. The connection circuits 15 can be metal such as aluminum, tin, silver, copper, gold and alloy, or others.

The cold end 12 of the thermoelectric cooler 10 comprises a metal core printed circuit board (MCPCB) 120 and a first insulated metal oxide film 122. The metal core printed circuit board 120 includes a first metal base 1200, a copper foil layer 1202, and an insulated layer 1404 sandwiched between the first metal base 1200 and the copper foil layer 1202. The hot end 14 of the thermoelectric cooler 10 comprises a second metal base 140 and a second insulated metal oxide film 142.

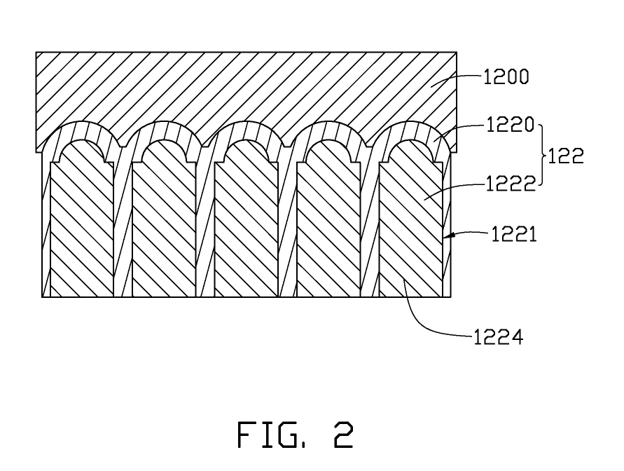

The first and second insulated metal oxide films 122, 142 correspond to the first and second metal bases 1200, 140, respectively. The first insulated metal oxide film 122 is formed on the first metal base 1200 by application of a layer of anodic aluminum oxide (AAO). For example, when forming the first insulated metal oxide film 122, the metal core printed circuit board 120 with the first metal base 1200 thereof connected to an anode can be immersed in electrolyte containing acidizing fluid, such as sulfuric acid, oxalic acid, phosphoric acid or chromic acid fluid. The anode is electrically connected to a power source. The first metal base 1200 and the acidizing fluid react to form the first insulated metal oxide films 122. In the embodiment, the first metal base 1200 is preferably metal with high thermal conductivity, such as aluminum, and an aluminum oxide film 1220 is formed thereon. As shown in FIG. 2, the aluminum oxide film 1220 has a plurality of void structures 1221 defined away from the first metal base 1200. The void structures 1221 are uniformly arranged and filled with insulated materials 1224, such as monox, alumina, spin on glass (SOG), organic compounds, or others. It can be understood that the second metal base 140 may also be aluminum, and the second insulated metal oxide films 142 may be formed on the second metal base 140 by application of a layer of anodic aluminum oxide. Therefore, the second insulated metal oxide film 142 and the first insulated metal oxide film 122 have the same structure.

The first and second insulated metal oxide films 122, 142 can be formed by other methods, such as macro-arc oxidation (MAO). During formation of the first insulated metal oxide films 122 on the first metal base 1200 by MAO, the metal core printed circuit board 120 with the first metal base 1200 thereof connected to an anode is immersed in electrolyte containing halides solution, such as potassium hydroxide or silicate. The anode is electrically connected to a power source, and the micro-arc discharges electricity from a surface of the first metal base 1200. Thus, the surface of the first metal base 1200 is melted, and the first insulated metal oxide films 122 is sintered on the first metal base 1200. In this embodiment, the first metal base 1200 is an aluminum layer with a depth of 0.5 mm, and depth of the first insulated metal oxide films 122 formed on the first metal base 1200 is approximately 0.2 mm.

The first and second metal bases 1200, 140 are metal with high thermal conductivity, and the first and second insulated metal oxide films 122, 142 are metal oxide films corresponding to the first and second metal bases 1200, 140. Thus, the first and second insulated metal oxide films 122, 142 also have high thermal conductivity, increasing heat transfer efficiency from the cold end 12 of the thermoelectric cooler 10 to the hot end 14.

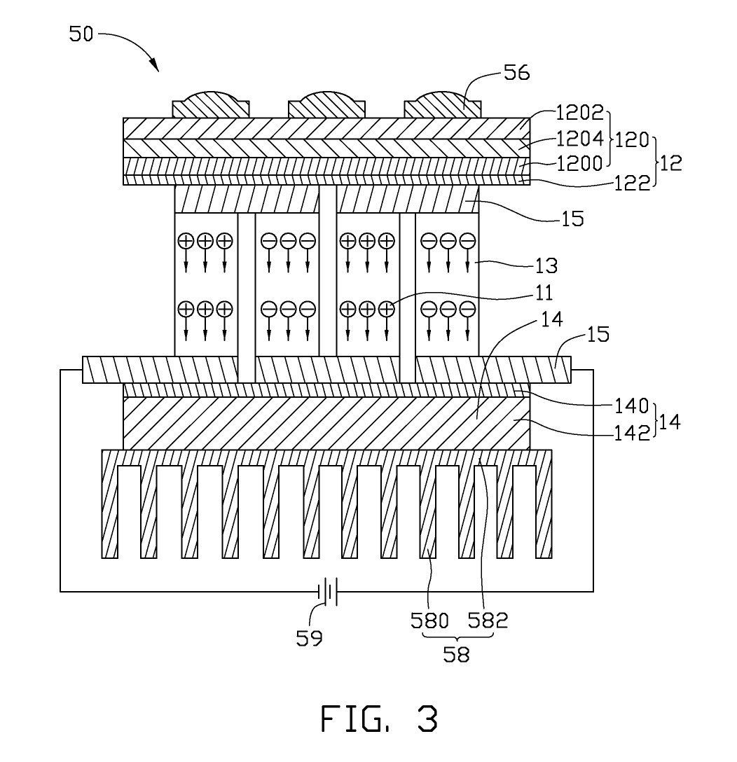

FIG. 3 shows an illumination device 50, in accordance with a second embodiment. The illumination device 50 comprises at least one solid-state light source 56, a heat dissipation device 58, and the thermoelectric cooler 10 of the first embodiment. The thermoelectric cooler 10 is employed in the illumination device 50, transferring heat generated by the at least one solid-state light source 56 to the heat dissipation device 58, where the heat is dissipated to the atmosphere.

The at least one solid-state light source 56 includes a plurality of LEDs. The LEDs can be white or multicolored such as red, green and blue. The LEDs 56 are mounted on the copper foil layer 1202 (a circuit is defined on the copper foil layer 1202) of the metal core printed circuit board 120 by eutectic bonding or solder bonding.

The heat dissipation device 58 comprises a base 582 and a number of fins 580 extending from the base 582 and substantially perpendicular to the base 582. The base 582 is coupled on the second metal base 140 of the hot end 14 by eutectic bonding or solder bonding, and thermally contacts the hot end 14.

During operation, an exterior power supply 59 having an anode and a cathode is applied to supply power to the thermoelectric cooler 10, wherein the P-type and N-type semiconductor elements 11, 13 are electrically connected to the anode and the cathode, respectively. Heat is generated from the LEDs 56 during illumination. When the power supply 59 supplies electric current to the thermoelectric cooler 10, electrons with negative electricity in the N-type semiconductor elements 13 move to the anode, and holes with positive electricity in the P-type semiconductor elements 11 move to the cathode. Heat generated by the LEDs 56 is thus transferred to the hot end 14 from the cold end 12 of the thermoelectric cooler 10 by electrical energy. The heat accumulated on the hot end 14 of the thermoelectric cooler 10 is immediately dissipated via the fins 580 of the heat dissipation device 58, from which the heat is dissipated to the atmosphere. Thus, by the provision of the thermoelectric cooler 10, efficiency of the heat dissipation of the LEDs 56 is improved, such that illumination device 50 operates continually within an acceptable temperature range, achieving stable optical performance.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A thermoelectric cooler, comprising a plurality of P-type semiconductor elements, a plurality of N-type semiconductor elements, and a plurality of connection circuits, wherein the P-type semiconductor elements electrically connect to the N-type semiconductor elements by the connection circuits, and the P-type semiconductor elements, the N-type semiconductor elements, and the connection circuits are sandwiched between the cold end and the hot end, providing thermal connection therebetween, and the cold end comprising a first metal base and a first insulated metal oxide film formed and located on a side of the first metal base adjacent to the P-type semiconductor elements, the N-type semiconductor elements and the connection circuits.

2. The thermoelectric cooler of claim 1, wherein the first insulated metal oxide film is metal oxide corresponding to metal materials of the first metal base.

3. The thermoelectric cooler of claim 1, wherein the first metal base is aluminum, and the insulated metal oxide film is formed on the first metal base by application of a layer of anodic aluminum oxide.

4. The thermoelectric cooler of claim 3, wherein the first insulated metal oxide film comprises aluminum oxide and filling material filling in the aluminum oxide.

5. The thermoelectric cooler of claim 4, wherein the filling material is monox, alumina, spin on glass or organic compounds.

6. The thermoelectric cooler of claim 1, further comprising a copper foil layer and an insulated layer, the insulated layer sandwiched between the first metal base and the copper foil layer, and the first metal base, the insulated layer, and the copper foil layer form a metal core printed circuit board.

7. The thermoelectric cooler of claim 1, wherein the hot end comprises a second metal base and a second insulated metal oxide film, and the second insulated metal oxide film is formed on a side of the second metal base adjacent to the P-type semiconductor elements, the N-type semiconductor elements and the connection circuits.

8. The thermoelectric cooler of claim 1, wherein the second insulated metal oxide film is metal oxide corresponding to metal materials of the second metal base.

9. An illumination device, comprising:
at least one solid-state light source;
a heat dissipation device; and
a thermoelectric cooler comprising a plurality of P-type semiconductor elements, a plurality of N-type semiconductor elements, a plurality of connection circuits, a cold end and a hot end, wherein the P-type semiconductor elements electrically connect to the N-type semiconductor elements by the connection circuits, and the P-type semiconductor elements, the N-type semiconductor elements and the connection circuits are sandwiched between the cold end and the hot end providing thermal connection therebetween, and the cold end comprises a first metal base and a first insulated metal oxide film formed on a side of the first metal base adjacent to the P-type semiconductor elements, the N-type semiconductor elements and the connection circuits, and the cold end thermally contacts the at least one solid-state light source, and the hot end thermally contacts the heat dissipation device.

10. The illumination device of claim 9, wherein the at least one solid-state light source comprises a plurality of light emitting diodes.

11. The illumination device of claim 10, further comprising a copper foil layer and an insulated layer, with the insulated layer sandwiched between the first metal base and the copper foil layer, and the first metal base, the insulated layer and the copper foil layer forming a metal core printed circuit board, the copper foil layer forming a circuit, and the LEDs are mounted on the circuit of the copper foil layer by eutectic bonding or solder bonding.

12. The illumination device of claim 9, wherein the hot end comprises a second metal base and a second insulated metal oxide film, and the second insulated metal oxide film is formed on a side of the second metal base adjacent to the P-type semiconductor elements, the N-type semiconductor elements and the connection circuits.

13. The illumination device of claim 12, wherein the heat dissipation device comprises a base thermally contacting the hot side of the thermoelectric cooler and a plurality of fins extending from the base away from the hot side, and the second metal base is coupled to the base of the heat dissipation device by eutectic bonding or solder bonding.
